(19) United States
(12) Patent Application Publication
(10) Pub. No.: US 2006/0108866 A1
(43) Pub. Date: May 25, 2006

(54) Apparatus which is a self contained trailer axle assembly that collects, stores and uses momentum energy

(76) Inventor: Scott Alan Hunter, Alton, NH (US)

Correspondence Address: Scott A. Hunter, 252 Coffin Brook Rd., Alton, NH, 03809, US

(21) Appl. No.: 11/223,843

(22) Filed: Sep. 9, 2005

Related U.S. Application Data
(63) Continuation-in-part of application No. 10/994,805, filed on Nov. 22, 2004, now abandoned.

(51) Int. Cl. B60T 8/64

(52) U.S. Cl. 303/152; 303/151

(57) ABSTRACT

An apparatus which is a self contained trailer axle assembly that collects, stores and uses momentum energy with a hydraulic pump to engage the spinning trailer wheel to collect momentum energy when slowing or stopping the trailer, a hydraulic accumulator connected to the pump to store the energy until needed, a safety relief valve to redirect excess energy generated by the pump, and a hydraulic motor connected to a trailer wheel to use the energy from the accumulator spinning the wheel in the desired direction. In a preferred embodiment the invention will be an assembly of the component parts in one unit and can be used by trailer builders in place of the existing trailer axle assembly's which have no energy collecting ability.

### CROSS REFERENCE TO RELATED APPLICATIONS

This is a continuation in part of Ser. No. 10/994,805, filed on Nov. 22, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of transportation and more specifically to an apparatus which is a self contained trailer axle assembly that collects, stores and reuses the momentum energy to help move the trailer and its load. Trailer axle assembly's are manufactured by many different companies for use in building trailers of all sizes and uses. In their past and present form trailer axle assemblies basically consist of an axle with wheels attached to each end with brakes and sometimes springs are attached to the axle. Trailer axle assemblies vary greatly in configuration depending on the trailer type and size they will be used on.

To this point in time there are no trailer axle assemblies being produced with a system incorporated into it that will collect momentum energy that could be retrieved when traveling down steep grades or when bringing the trailer to a stop at a light, stop sigh or any other time forward momentum of the trailer must be slowed or stopped. In other areas of momentum energy retrieval there are some very important innovative accomplishments. Some of them are:

Tazoe U.S. Pat. No. 6,739,677 which is a device to suppress the fluctuations while decelerating when regenerative braking is used in a hybrid gas and electric motor vehicle. This is a specific problem solving device which arises when mixing conventional braking and regenerative braking on a hybrid motor vehicle.

Palmer U.S. Pat. No. 6,866,350 which is a device to be used on a motor home while towing a hybrid electric and gas motor vehicle with regenerative brakes in order to take advantage of the regenerative brakes on the car being towed. This allows the motor home to use the regenerative brakes on the car being towed to help stop both vehicles and charge the batteries at the same time. Until Palmer, if the vehicle being towed was to heavy for the motor home to stop, the towed vehicle would need to be on a trailer with brakes to help stop both vehicles.

Schneider U.S. Pat. No. 6,325,470 is a device to solve another problem in hybrid electric vehicles which is evenly distributing the braking/regenerating pressures to each wheel and also preventing skidding when a wheel encounters slippery surface.

These technologies address and solve particular problems having to do with hybrid cars and some of their solutions could help us in further refining our energy collecting trailer axle assembly but at this point in time are unforeseen.

There is a technology being developed that sends hydraulic power from the transmission of the towing vehicle to the trailer axle which spins the trailer wheels giving more traction to move forward in slippery or difficult positions. Trailer axle assemblies manufactured now go from simple to complex depending on the need of the trailer it will be installed on but there are no self contained trailer axle assemblies yet that will retrieve lost momentum then store and use the momentum power to help bring the payload back up to speed.

A trailer axle assembly that uses hydraulic power from the pulling vehicle's transmission to spin the trailer wheels uses energy from the engine and does not save energy but uses more fuel from the pulling vehicle while redistributing the power to the trailer wheels. This technology isn't intended to be a fuel saving device but is intended to be a solution to a different problem.

### BRIEF SUMMARY OF THE INVENTION

The primary object of the invention is to provide a self contained trailer axle assembly that collects, stores and reuses momentum energy.

Another object of the invention is to provide an energy collecting trailer axle assembly to fit new and replace axle assemblies in older trailers.

Another object of the invention is to provide an energy collecting trailer axle assembly in different sizes to fit different size trailers.

A further object is to provide a trailer axle assembly that efficiently retrieves momentum when slowing or stopping using it when most needed to help move the trailer for faster acceleration and saving fuel.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus which is a self contained trailer axle assembly that collects, stores and uses momentum energy comprising: a hydraulic pump to engage the spinning trailer wheel to collect momentum energy when slowing or stopping the trailer, a hydraulic accumulator connected to the pump to store the energy until needed, a safety relief valve to redirect excess energy generated by the pump, and a hydraulic motor connected to a trailer wheel to use the energy from the accumulator spinning the wheel in the desired direction in order to help accelerate and save fuel. dr

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIGURE 1 is an elevation view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

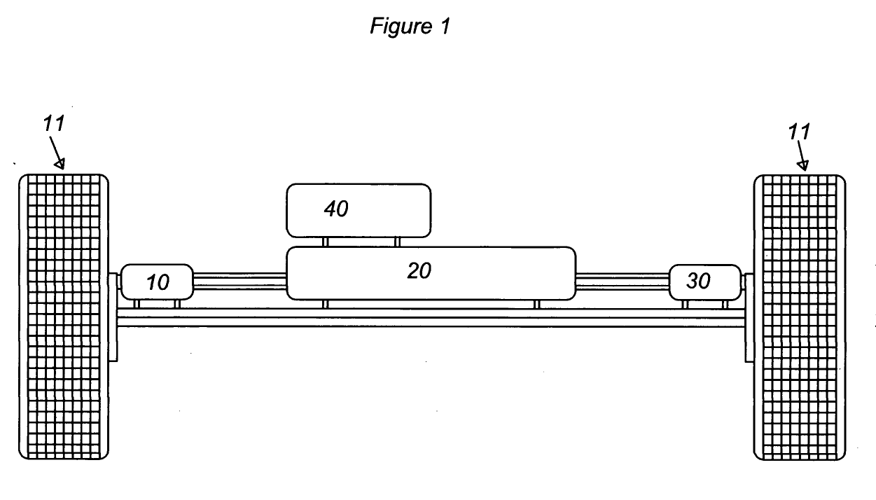

Turning to FIGURE 1 there is shown a generic trailer axle assembly with the components that make up the present invention. The trailer axle assembly alone is not new and consists of an axle with wheels on each end, brakes and a way to mount a trailer body to the trailer axle assembly. However when adding to this assembly a hydraulic pump 10 that will engage the spinning trailer wheel 11 in order to collect momentum energy when slowing or stopping the trailer; Moreover adding a hydraulic accumulator 20 connected to the pump to store the energy until needed; Moreover adding a hydraulic motor 30 connected to a trailer wheel to use the energy from the accumulator, spinning the wheel 11 in the desired direction; In like manner adding a safety relief device 40 in order to release and redirect any excess pressure in the hydraulic accumulator 20.

In a little more detail the hydraulic pump 10 could engage the wheel using a lose v belt (similar to the belt drive on a snow mobile) that would be tightened when the brake peddle (of the towing vehicle) is touched or the accelerator peddle is completely released. The pump 10 when engaged will put drag on the trailer wheel 11 pumping hydraulic fluid to the hydraulic accumulator 20 which will hold the energy until needed. The hydraulic motor 30 could be engaged to the wheel using a loose v belt with pulleys like that of a snowmobile clutch and activated to use the power from the accumulator by a switch on the accelerator peddle of the pulling vehicle. The v belt connections can be replaced by other means that would accomplish the desired result. The energy can also be retrieved, stored and delivered in different ways such as pneumatic or compressed air. Or the retrieval, storage and using of the energy can be accomplished by winding tension into a spring or series of flexible bands, holding the tension in until needed and unwinding the tension into the wheels through the v belt system described above or other means that would accomplish the desired result.

These components together make a new apparatus which is a self contained trailer axle assembly that collects, stores and uses momentum energy independently from any other power source that may be used to pull a trailer.

It is to be noted that the energy collecting trailer axle assembly when used in conjunction with a trailer body and is being pulled by a motor vehicle that the operator can use the energy collected in the trailer axle assembly to help move the load on the trailer which relieves some strain from the pulling vehicle which will save fuel and wear on the motor vehicle. It is also noted that the hydraulic devices can be replaced by pneumatic devices or mechanical energy storage such as springs or flexible bands or other means of energy storage.

In its present form the invention is a way to retrieve energy normally wasted when slowing or stopping a trailer and reuse that energy without major changes in the towing vehicle itself. Also the said invention is an independent device which can be used along side other existing fuel saving devices and practices. Furthermore the present invention can be easily retrofit to existing trailers. Still another advantage is trailer builders can install the said energy collecting trailer axle assembly to their trailers without major design changes.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus which is a self contained trailer axle assembly that collects, stores and uses momentum energy comprising:
a hydraulic pump to engage the spinning trailer wheel to collect momentum energy when slowing or stopping the trailer;
a hydraulic accumulator connected to the pump to store the energy until needed;
a safety relief valve to redirect excess energy generated by the pump; and
a hydraulic motor connected to a trailer wheel to use the energy from the accumulator spinning the wheel in the desired direction.
